(19) United States
(12) Patent Application Publication
(10) Pub. No.: US 2002/0035936 A1
(43) Pub. Date: Mar. 28, 2002

(54) Inking apparatus for printing press

(76) Inventors: Hiroyoshi Kamoda, Higashikatsushika-gun (JP); Masaki Yokoyama, Higashikatsushika-gun (JP)

Correspondence Address: BIRCH STEWART KOLASCH & BIRCH, PO BOX 747, FALLS CHURCH, VA, 22040-0747, US

(21) Appl. No.: 09/842,765

(22) Filed: Apr. 27, 2001

(30) Foreign Application Priority Data
Apr. 28, 2000 (JP) 2000-128853

(51) Int. Cl. B41F 31/00; B41F 31/02

(52) U.S. Cl. 101/350.1

(57) ABSTRACT

An inking apparatus for a printing press comprises upper and lower fountain rollers disposed and rotatably supported in respective ink fountain apparatuses; upper and lower ductor rollers supported to be rotatable in close proximity with the fountain rollers; and an ink mixing roller which is the furthest upstream ink roller to which ink is transferred from the upper and lower ductor rollers. In the inking apparatus, an intermediate metal roller and an intermediate rubber roller are provided between the ink mixing roller and at least one of the upper ductor roller and the lower ductor roller.

The entire disclosure of Japanese Patent Application No. 2000-128853 filed on Apr. 28, 2000 including specification, claims, drawings and summary is incorporated herein by reference in its entirety.

### BACKGROUND OF THE INVENTION

1. Field of the Invention

The present invention relates to an inking apparatus for a printing press, and, more particularly, to an inking apparatus for a printing press capable of performing rainbow printing.

2. Description of the Related Art

An example of such printing press is a four-color double-sided simultaneous offset printing press as shown in FIG. 3.

In a printing unit 1 of the main unit, a rubber impression cylinder 2 having a paper gripping apparatus and a rubber cylinder 3 having no paper gripping apparatus are supported substantially horizontally such that the circumferential surfaces of the cylinders 1 and 2 are in contact with each other.

Four plate cylinders 4 are disposed along the circumferential surface of the rubber impression cylinder 2; and four plate cylinders 5 are disposed along the circumferential surface of the rubber cylinder 3. Inking units 6 and 7 are movably disposed such that the inking units 6 and 7 can approach and separate from the plate cylinders 4 and 5, respectively. The inking units 6 and 7 can supply ink and water to the plate cylinders 4 and 5 in a state in which the inking units 6 and 7 are in contact with the plate cylinders 4 and 5.

Meanwhile, a delivery cylinder 9 of a delivery unit 8 is disposed below the rubber impression cylinder 2. A chain 10 is disposed on the left side of the delivery cylinder 9 in FIG. 3, such that the chain 10 does not cross a space below the position at which the circumferential surface of the rubber impression cylinder 2 is in close proximity with that of the rubber cylinder 3.

Further, transfer cylinders 12 to 15 each having a paper gripping apparatus are provided in order to transfer paper from a register 11 to the rubber impression cylinder 2; and a transfer cylinder 16 having a paper gripping apparatus is provided in order to transfer paper from the rubber impression cylinder 2 to the delivery cylinder 9. In FIG. 3, reference numeral 17 denotes a feeder unit.

Accordingly, a sheet of paper fed from the feeder unit 17 and positioned by the register 11 is conveyed along a path indicated by arrows in FIG. 3; i.e., is conveyed along the circumferential surfaces of the transfer cylinders 12 to 15, the circumferential surface of the rubber impression cylinder 2, the circumferential surface of the transfer cylinder 16, and the circumferential surface of the delivery cylinder 9, in this sequence. When the sheet of paper passes through the contact point between the rubber impression cylinder 2 and the rubber cylinder 3 from the upper side to the lower side of the contact point, the opposite faces of the sheet of paper undergo printing simultaneously.

As shown in FIG. 4, in each of the inking units 6 and 7, an upper set consisting of an ink fountain roller 21a and an ink ductor roller 22a and a lower set consisting of an ink fountain roller 21b and an ink ductor roller 22b are provided. The ink fountain rollers 21a and 21b are disposed and rotatably supported in respective ink fountain apparatuses 20a and 20b. The ink ductor rollers 22a and 22b are supported to be rotatable in close proximity with the ink fountain rollers 21a and 21b and be swingable. Ink is transferred from these upper and lower rollers to an ink mixing (distribution) roller 23 and then transferred to an ink form roller 25 via an ink roller group 24 including an ink distribution roller and an ink oscillating roller. In FIG. 4, reference numeral 26 denotes an ink roller group for another color.

When so-called rainbow printing; i.e., printing adjacent areas in different colors while shading off the colors at the boundary portion therebetween, is to be performed, inks of different colors are charged in the two ink fountain apparatuses 20a and 20b, and printing is then performed. Since mixing of colors does not occur in the ink fountain apparatuses, quality of printing products is improved, and a larger amount of ink can be stored in the ink fountains in order to improve productivity.

However, in the above-described conventional inking apparatus, within each of the inking units 6 and 7, the upper and lower ink fountain apparatuses 20a and 20b are disposed radially with respect to the ink mixing roller 23 with the same number of rollers being interposed for each ink fountain, whereby ink stored in each ink fountain is transferred to the ink mixing roller 23.

Therefore, when the ink ductor rollers 22a and 22b are exchanged in order to cope with a change in printing specification of rainbow printing or the like, an operator must move the inking units 6 and 7 or must move between the opposite sides of the inking units 6 and 7, because the ink ductor rollers 22a and 22b differ from each other in removal direction (see arrows in FIG. 4). In some cases, the ink from roller 25 also must be removed temporarily. Therefore, a very long work time is needed to complete the exchange work.

Further, since a sufficient work space is not present on the upper side of the lower ink fountain apparatus 20b, attachment of the ink ductor roller 22b involves lifting the ink ductor roller 22b from below, and removal of the ink ductor roller 22b involves supporting the ink ductor roller 22b from below. These operations are heavy labor for the operator, resulting in imposition of a large workload on the operator.

Furthermore, in each of the inking unit 6 and 7, the operator must perform the replacement work within a narrow work space between the ink roller group 24 and the ink roller group 26 for another color disposed above the ink roller group 24. Therefore, the operator encounters difficulty in performing the work, and a large workload is imposed on the operator. In addition to the above-described problem, the conventional inking apparatus involves various other problems.

### SUMMARY OF THE INVENTION

In view of the foregoing, an object of the present invention is to provide an inking apparatus for a printing press, which can shorten operator's work time and lessen workload imposed on the operator.

In order to achieve the above-described object, the present invention provides an inking apparatus for a printing press comprising: upper and lower fountain rollers disposed and rotatably supported in respective ink fountain apparatuses; upper and lower ductor rollers supported to be rotatable in close proximity with the fountain rollers; and an ink mixing roller which is the furthest upstream ink roller to which ink is transferred from the upper and lower ductor rollers, wherein an intermediate roller is provided between the ink mixing roller and at least one of the upper ductor roller and the lower ductor roller.

Since attachment and removal of the upper and lower ink ductor rollers can be performed from the side of the ink fountain apparatuses where a large work space is provided, operator's work time can be shortened, and the workload imposed on the operator can be lessened.

Preferably, the upper and lower ductor rollers are supported to be removable upward. In this case, the workload imposed on the operator can be decreased further.

Preferably, opposite axial end portions of each of the upper and lower ductor rollers are supported, via split holders, on arms fixed to opposite end portions of a swing support shaft; and upper halves of the split holders can be swung upward to open to thereby enable upward removal of the upper and lower ductor rollers.

Preferably, the intermediate roller is provided between the lower ductor roller and the ink mixing roller.

Preferably, the intermediate roller consists of first and second intermediate rollers.

### BRIEF DESCRIPTION OF THE DRAWINGS

FIG. 1 is a schematic structural view showing the inside of an inking unit according to one embodiment of the present invention;

FIG. 2 is an enlarged view of a main portion of FIG. 1;

FIG. 3 is an overall side view of a four-color double-sided simultaneous offset printing press; and

FIG. 4 is a schematic structural view showing the inside of a conventional inking unit.

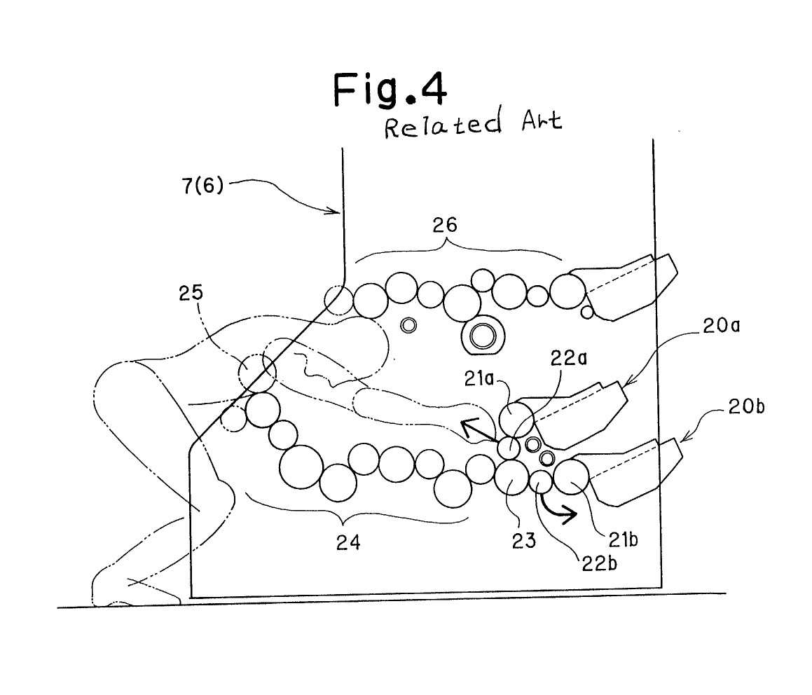

### DESCRIPTION OF THE PREFERRED EMBODIMENT

An inking apparatus for a printing press according to the present invention will next be described by way of an embodiment and with reference to the drawings.

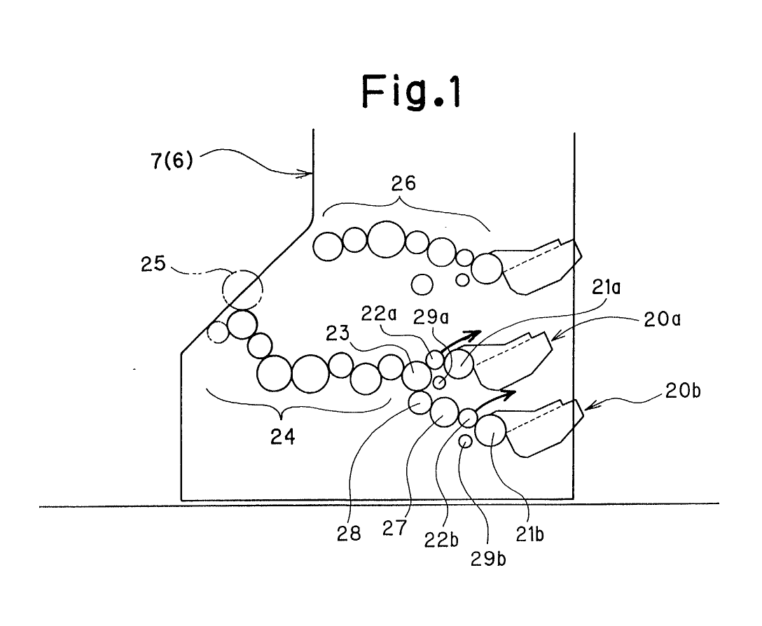

As shown in FIG. 1, in each of inking units 6 and 7, an upper set consisting of an ink fountain roller 21a and an ink ductor roller 22a and a lower set consisting of an ink fountain roller 21b and an ink ductor roller 22b are provided. The ink fountain rollers 21a and 21b are disposed and rotatably supported in respective ink fountain apparatuses 20a and 20b. The ink ductor rollers 22a and 22b are supported to be rotatable in close proximity with the ink fountain rollers 21a and 21b and be swingable about respective swing support shafts 29a and 29b.

On the side of the upper ink fountain apparatus 20a, ink is transferred from the upper ductor roller 22a directly to an ink mixing (distribution) roller 23. In contrast, on the side of the lower ink fountain apparatus 20b, ink is transferred from the lower ductor roller 22b to the ink mixing (distribution) roller 23 via a first intermediate roller 27 formed of metal and a second intermediate roller 28 formed of rubber. The inks are then transferred from the ink mixing (distribution) roller 23 to an ink form roller 25 via an ink roller group 24 including an ink distribution roller and an ink oscillating roller.

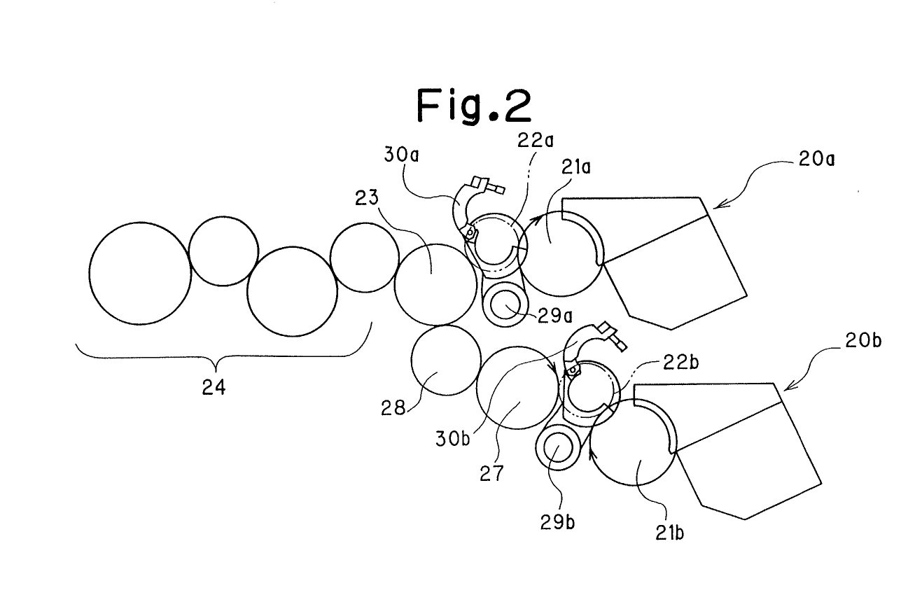

As shown in FIG. 2, split holders 30a are provided on arms fixed to the opposite end portions of the swing support shaft 29a; and split holders 30b are provided on arms fixed to the opposite end portions of the swing support shaft 29b. The opposite axial end portions of the upper ink ductor roller 22a are supported by the split holders 30a; and the opposite axial end portions of the upper ink ductor roller 22b are supported by the split holders 30b. Upper halves of the split holders 30a and 30b can be swung upward to open to thereby enable upward removal of the upper and lower ink ductor rollers 22a and 22b.

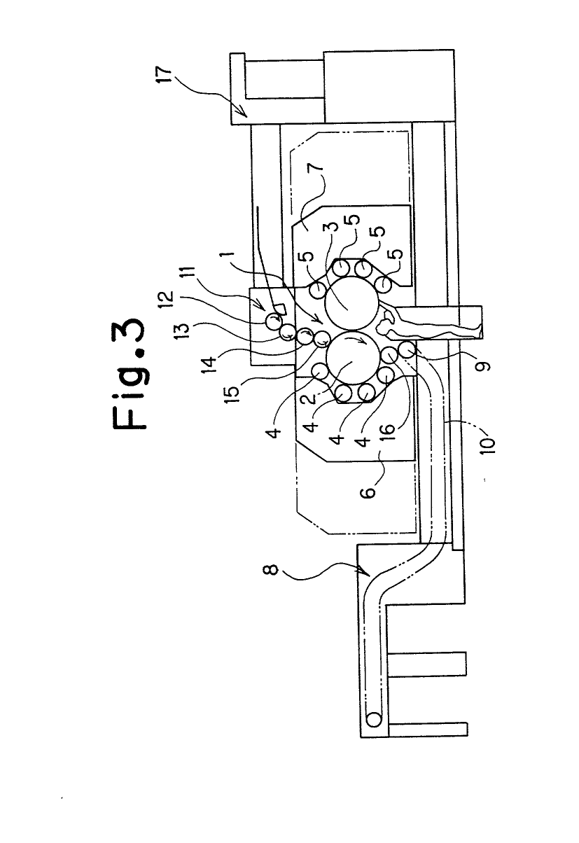

Since the structure of the remaining portion is the same as that shown in FIG. 3, detailed description thereof is not repeated here.

As described above, in the present embodiment, the intermediate rollers 27 and 28 are disposed on the side of the lower ink fountain apparatus 20b in order to increase the length of the row of rollers. Therefore, a work space can be secured above the lower ink fountain apparatus 20b.

In addition, since a work space can be secured above the lower ink fountain apparatus 20b, on the side of the upper ink fountain apparatus 20a, rollers can be disposed in such a manner that the ink fountain roller 21a and the ink ductor roller 22a are arranged along a substantially horizontal direction with respect to the ink mixing roller 23.

As a result, attachment and removal of the upper and lower ink ductor rollers 22a and 22b can be performed from the side of the ink fountain apparatuses 20a and 20b where a large work space can be secured. Therefore, the work time of the operator can be shortened, and the workload imposed on the operator can be lessened.

Moreover, since the split holders 30a and 30b support the upper and lower ductor rollers 22a and 22b such that the operator can remove the upper and lower ductor rollers 22a and 22b to the upward direction, the operator can attach the ductor rollers 22a and 22b while lowering them from above. Therefore, the workload imposed on the operator can be lessened.

The present invention is not limited to the above-described embodiment, and may be modified in various manners without departing from the scope of the present invention. For example, two or more intermediate rollers may be provided on the upper ink fountain apparatus 20a as well as on the upper ink fountain apparatus 20a, or may be provided on the upper ink fountain apparatus 20a only.

What is claimed is:

1. An inking apparatus for a printing press comprising:
upper and lower fountain rollers disposed and rotatably supported in respective ink fountain apparatuses;
upper and lower ductor rollers supported to be rotatable in close proximity with said fountain rollers; and
an ink mixing roller which is the furthest upstream ink roller to which ink is transferred from said upper and lower ductor rollers, wherein
an intermediate roller is provided between said ink mixing roller and at least one of said upper ductor roller and said lower ductor roller.

2. An inking apparatus for a printing press according to claim 1, wherein said upper and lower ductor rollers are supported to be removable upward.

3. An inking apparatus for a printing press according to claim 2, wherein opposite axial end portions of each of said upper and lower ductor rollers are supported, via split holders, on arms fixed to opposite end portions of a swing support shaft; and upper halves of said split holders can be swung upward to open to thereby enable upward removal of said upper and lower ductor rollers.

4. An inking apparatus for a printing press according to claim 1, wherein said intermediate roller is provided between said lower ductor roller and said ink mixing roller.

5. An inking apparatus for a printing press according to claim 4, wherein said intermediate roller consists of first and second intermediate rollers.
